(19) United States
(12) Patent Application Publication
(10) Pub. No.: US 2017/0036486 A1
(43) Pub. Date: Feb. 9, 2017

(54) Crown Reinforcement For An Airplane Tire

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Vincent ESTENNE, Clermont-Ferrand Cedex 9 (FR); Emmanuel JOULIN, Clermont-Ferrand Cedex 9 (FR)

(21) Appl. No.: 15/304,622

(22) PCT Filed: Apr. 17, 2015
(86) PCT No.: PCT/EP2015/058344

§ 371 Date: Oct. 17, 2016

(30) Foreign Application Priority Data
Apr. 18, 2014 (FR) 1453525

(51) Int. Cl. B60C 9/26; B60C 9/18; B60C 9/00

(52) U.S. Cl. CPC B60C 9/263; B60C 9/0007; B60C 9/005; B60C 9/1807; B60C 9/0042; B60C 2200/02

(57) ABSTRACT

Airplane tire comprises working reinforcement (2) radially inside of tread (3) and radially outside of carcass reinforcement (4). working reinforcement (2) comprises working biply (21). The radially innermost working biply (21) has the greatest axial width (L_{T}) and comprises two axial ends (E). Carcass reinforcement (4) comprises carcass layer (41). Distance (D) between axial end (E) of the radially innermost working biply (21) and its orthogonal projection (I) onto the radially outermost carcass layer (41) is at least equal to 8 mm. Distance (D′) between point (F) of radially innermost working biply (21), axially inside of axial end (E) at a distance (L) equal to 25 mm, and its orthogonal projection (J) onto the radially outermost carcass layer (41) is at most equal to the distance (D) and is such that angle (A) equal to atan[(D−D′)/L] is at least equal to 12°.

The present invention relates to a tire for an aeroplane and, in particular, to an aeroplane tire crown reinforcement.

In what follows, the circumferential, axial and radial directions respectively denote a direction tangential to the tread surface of the tire in the direction of rotation of the tire, a direction parallel to the axis of rotation of the tire and a direction perpendicular to the axis of rotation of the tire. “Radially inside or, respectively, radially outside” means “closer to, or, respectively, further away from, the axis of rotation of the tire”. “Axially inside or, respectively, axially outside” means “closer to, or, respectively, further away from, the equatorial plane of the tire”, the equatorial plane of the tire being the plane passing through the middle of the tread surface of the tire and perpendicular to the axis of rotation of the tire.

In general, a tire comprises a tread intended to come into contact with the ground via a tread surface, the tread being connected by two sidewalls to two beads, the two beads being intended to provide mechanical connections between the tire and a rim on which the tire is mounted.

A radial aeroplane tire more particularly comprises a radial carcass reinforcement and a crown reinforcement, as described, for example, in document EP 1381525.

The radial carcass reinforcement is the tire reinforcing structure that connects the two beads of the tire. The radial carcass reinforcement of an aeroplane tire generally comprises at least one carcass layer, each carcass layer being made up of reinforcers, usually textile, coated in a polymeric material of the elastomer or elastomer compound type, these reinforcers being mutually parallel and forming, with the circumferential direction, an angle comprised between 80° and 100°.

The crown reinforcement is the tire reinforcing structure radially on the inside of the tread and at least partially radially on the outside of the radial carcass reinforcement. The crown reinforcement of an aeroplane tire generally comprises at least one crown layer, each crown layer being made up of reinforcers that are mutually parallel and coated in a polymeric material of the elastomer or elastomer compound type. Among the crown layers, a distinction is usually made between the working layers that make up the working reinforcement and are usually made of textile reinforcers, and the protective layers, that make up the protective reinforcement, and are made of metal or textile reinforcers and are arranged radially on the outside of the working reinforcement. The working reinforcement dictates the overall mechanical behaviour of the crown reinforcement, whereas the protective reinforcement essentially protects the working layers from attack likely to spread through the tread radially toward the inside of the tire.

The textile reinforcers of the carcass layers and of the crown layers are usually cords made up of spun textile filaments, preferably made of aliphatic polyamide or of aromatic polyamide. The mechanical properties under extension, such as the elastic modulus, the elongation at break and the force at break of the textile reinforcers are measured after prior conditioning. “Prior conditioning” means the storage of the textile reinforcers for at least 24 hours, prior to measurement, in a standard atmosphere in accordance with European Standard DIN EN 20139 (temperature of 20±2° C.; relative humidity of 65±2%). The measurements are taken in the known way using a ZWICK GmbH & Co (Germany) tensile test machine of type 1435 or type 1445. The textile reinforcers are subjected to tension over an initial length of 400 mm at a nominal rate of 200 mm/min. All the results are averaged over 10 measurements.

During the manufacture of an aeroplane tire and, more specifically, during the step of laying the working reinforcement, a working layer is usually obtained by zigzag circumferential winding or circumferential winding in turns of a strip on a cylindrical laying surface having as its axis of revolution the axis of rotation of the tire. The strip is generally made up of at least one continuous textile reinforcer coated in an elastomeric compound and, most usually, of a juxtaposition of mutually parallel continuous textile reinforcers coated in an elastomeric compound. Whether created by zigzag circumferential winding or by circumferential winding in turns, the working layer is then therefore made up of the juxtaposition of portions of strip. The advantage of having zigzag circumferential winding or circumferential winding in turns is that, at the axial ends of the working layers, it avoids there being free ends of reinforcers liable to generate cracks in these zones and therefore to reduce the endurance of the working reinforcement and the life of the tire.

What is meant by circumferential winding in turns of a strip is a winding of the strip, in the circumferential direction, and in a helix of radius equal to the radius of the cylindrical laying surface and at a mean angle, with respect to the circumferential direction, comprised between 0° and 5°. The working layer thus obtained by winding in turns is said to be circumferential because the angle between the textile reinforcers, pairs of which are mutually parallel, of the strip, formed in the equatorial plane and with the circumferential direction, is comprised between 0° and 5°.

What is meant by zigzag circumferential winding of a strip is winding of the strip, in the circumferential direction, and in a periodic curve, which means to say a curve made up of periodic undulations oscillating between extrema. Winding a strip with a periodic curve means that the mid-line of the strip, equidistant from the edges of the strip, coincides with the periodic curve. In the case of a zigzag circumferential winding, the midline of the strip forms, with the circumferential direction of the tire and in the equatorial plane of the tire, an angle at least equal to 8° and at most equal to 30°. In other words, the reinforcers that make up each working layer form, with the circumferential direction of the tire and in the equatorial plane of the tire, an angle at least equal to 8° and at most equal to 30°. During a zigzag circumferential winding of a strip, the working layers are laid in pairs, each pair of working layers constituting a working biply. Thus, a working biply is made up, in its main section, which means to say away from the axial ends thereof, of two radially superposed working layers. At its axial ends, a working biply generally comprises more than two radially superposed working layers. The number of additional working layers, in the radial direction, compared with the two working layers of the main section of the working biply are referred to as the axial end overthickness. This axial end overthickness is generated by the crossings of the strip, at the end of the working biply, for each turn of a zigzag winding. A working reinforcement such as this comprising working biplies obtained by zigzag circumferential winding of a strip has been described in documents EP 0240303, EP 0850787, EP 1163120 and EP 1518666.

It is known that the axial end overthicknesses of the working biplies and, in particular, those of the working biply of greatest axial width, are sensitive to the onset of endurance damage, such as cracks that may evolve into significant degradation of the working reinforcement and, in some instances, lead to a reduction in the life of the tire.

This is because in the axial end overthicknesses and the vicinity thereof, the thermomechanical stresses are very high, when the tire is compressed and driven on, in the conditions of service of an aeroplane. For example, and nonlimitingly, a commercial airline aeroplane tire may be subjected to a nominal pressure in excess of 15 bar, a nominal load in excess of 20 tonnes and a maximum speed of 360 km/h. This results in a significant dissipation of heat and therefore a high temperature level likely to limit the endurance performance of the tire.

The endurance performance of an aeroplane tire is generally measured on an elementary qualification test such as the TSO (Technical Standard Order) test imposed by an FAA (Federal Aviation Administration) standard.

The TSO test is a test performed on a rolling road and that is broken down into 4 phases:
50 aircraft takeoff cycles, in which the tire is subjected to the nominal pressure Pᵥ and to a load that varies between the nominal load Zₙ and 0.
8 aeroplane taxiing cycles, in which the tire is subjected to the nominal pressure Pᵥ, to the nominal load Zₙ and to a speed of around 65 km/h for approximately 10700 m.
2 aircraft taxiing cycles in which the tire is subjected to the nominal pressure Pᵥ at 1.2 times the nominal load Zₙ and at a speed of approximately 65 km/h for approximately 10700 m.
1 overloaded aircraft takeoff cycle in which the tire is subjected to the nominal load Pᵥ and to a load varying between 1.5 times the nominal load Zₙ and 0.

The objective of the TSO test is to perform all the cycles without any damage to the tire, although delamination of the tire, which means to say loss of the tread, is permitted during the final cycle, but not a loss in pressure.

There are solutions known to those skilled in the art for reducing the temperature at the axial ends of the working reinforcement, each of these solutions potentially having disadvantages:
use of a low-hysteresis elastomeric compound for the tread, this type of compound more often being sensitive to abrasion and therefore liable to accelerate tire tread wear;
use of a low hysteresis elastomeric compound for a first intermediate component, axially on the inside of the tread and axially on the outside of the protective reinforcement, but with the risk of decohesion between said first intermediate component and the tread under harsh operating conditions, particularly during the TSO test;
optimization of the geometric profile of a second intermediate component, axially on the inside of the protective reinforcement and axially on the outside of the working reinforcement, but which can give rise to premature appearance of said second intermediate compound at the surface of the tread, as the tread wears, hence leading to a risk of accelerated tread wear;
use of circumferential reinforcers for the working layers, which means to say of reinforcers forming a zero angle with the circumferential direction, something which may lead to a drop in the cornering stiffness of the tire and impaired control of its centrifugal inflated profile.

The inventors have set themselves the task of improving the endurance of the working reinforcement of an aeroplane tire by reducing the thermomechanical stresses at the axial end overthicknesses of the working biplies of which the working reinforcement is made.

This objective has been achieved, according to the invention, by an aeroplane tire comprising:
a working reinforcement radially on the inside of a tread and radially on the outside of a carcass reinforcement,
the working reinforcement comprising at least one working biply consisting at least in part of two radially superposed working layers,
each working layer comprising reinforcers coated in an elastomeric material, positioned circumferentially along a periodic curve and forming, with the circumferential direction of the tire and in the equatorial plane of the tire, an angle at least equal to 8° and at most equal to 30°,
the radially innermost working biply having the greatest axial width and comprising two axial ends each one corresponding to the axially outermost and radially innermost point of the working biply,
the carcass reinforcement comprising at least one carcass layer comprising reinforcers which are coated in an elastomeric material, forming, with the circumferential direction of the tire, an angle at least equal to 80° and at most equal to 100°,
the distance D between an axial end of the radially innermost working biply and its orthogonal projection onto the radially outermost carcass layer being at least equal to 8 mm and the distance D′ between the point on the radially innermost working biply, axially on the inside of the axial end at a distance L equal to 25 mm, and its orthogonal projection onto the radially outermost carcass layer being at most equal to the distance D and being such that the angle A=atan[(D−D′)/L] is at least equal to 12°.

According to the invention, the axial end of the radially innermost working biply, namely the axially outermost point, and the point on the radially innermost working biply, which is positioned axially on the inside of said axial end at a distance L equal to 25 mm, are positioned radially on the outside of the radially outermost carcass layer at respective distances D and D at least equal to minimal values. The distance D between the axial end of the radially innermost working biply and its orthogonal projection onto the radially outermost carcass layer is at least equal to 8 mm. The distance D′ between the point on the radially innermost working biply, axially on the inside of axial end at a distance L equal to 25 mm, and its orthogonal projection onto the radially outermost carcass layer is on the one hand, at most equal to the distance D and, on the other hand, such that the angle A=atan[(D−D′)/L] is at least equal to 12°. The angle A is the angle formed by the straight line passing through the axial end of the biply and by the point on the biply, positioned at 25 mm axially on the inside, and the straight line passing through their respective orthogonal projections onto the radially outermost carcass layer.

These minimum distances, which are greater than those usually found on a tire of the prior art, make it possible to obtain a geometric profile for the end of the radially innermost working biply that is further from the carcass reinforcement than is the case in a tire of the prior art. This geometric profile, recorded at the axial end, makes it possible to reduce the cyclic thermomechanical stresses at the axial end of the biply and, therefore, the temperature in this zone making it possible to improve the endurance of the working reinforcement and increase the life of the tire.

The distance D between the axial end of the radially innermost working biply and its orthogonal projection onto the radially outermost carcass layer is advantageously at most equal to 16 mm. This maximum value reduces the risk of the axial end of the working biply appearing at the surface of the tire if the axial end portion or shoulder of the tread wears away.

The distance D between the point on the radially innermost working biply, axially on the inside at a axial end at a distance L equal to 25 mm, and its orthogonal projection onto the radially outermost carcass layer is advantageously such that the angle A=atan[(D−D′)/L] is more advantageously still at least equal to 15°. A higher angle A, and therefore an even more pronounced axial end geometric profile allows an even more significant reduction in the cyclic thermomechanical stresses at the axial end of the biply and therefore of the temperature in this zone.

The distance D′ between the point of the radially innermost working biply, axially on the inside of the axial end at a distance L equal to 25 mm, and its orthogonal projection onto the radially outermost carcass layer is advantageously such that the angle A=atan[(D−D′)/L] is advantageously at most equal to 30°. This maximum value also reduces the risk of the axial end of the working biply appearing if the axial end portion, or shoulder, of the tread wears away.

The reinforcers of the working layers of any working biply are preferably made of a textile material. The textile guarantees a good compromise between the mass and the breaking strength of the reinforcers. The use of textile reinforcers for any working biply, which means to say for all the working layers, makes a significant contribution to minimizing the mass of the tire and therefore to maximizing the payload of the aeroplane. Among the textile reinforcers commonly used in aeroplane tires a distinction is made between reinforcers made of an aliphatic polyamide, such as nylon, and reinforcers made an aromatic polyamide such as aramid. Reinforcers made of an aromatic polyamide offer a better compromise between mass and breaking strength than do reinforcers made of aliphatic polyamide.

According to one preferred embodiment, the reinforcers of the working layers of at least the radially innermost working biply are advantageously hybrid reinforcers made up of a combination of an aliphatic polyamide and an aromatic polyamide. The radially innermost biply that has the greatest axial width has the most heavily mechanically loaded axial ends hence the benefit in using, for the working layers of this working biply, hybrid reinforcers which offer both the advantages of an aliphatic polyamide and those of an aromatic polyamide: high breaking strength, high tensile deformability and lightness of weight.

According to another preferred embodiment the tire comprises a hoop reinforcement comprising at least one hooping layer comprising reinforcers which are coated in an elastomeric material, forming, with the circumferential direction of the tire, an angle at most equal to 5°, at least one hooping layer being radially on the inside of the radially innermost working biply and having an axial width at most equal to 0.8 times the axial width of the radially innermost working biply. The hoop reinforcement is a reinforcement centred on the equatorial plane of the tire and made up of at least one hooping layer comprising reinforcers coated in an elastomeric material. The reinforcers, usually textile, form, with the circumferential direction of the tire, an angle at most equal to 5°, which means to say that they are substantially circumferential. The axial width of the hoop reinforcement, which is defined by the axial width of the axially widest hooping layer, is at most equal to 0.8 times the axial width of the radially innermost working biply, namely an axial width that is limited with respect to that of the working reinforcement. Finally, usually although not exclusively, a hooping layer is radially on the inside of the radially innermost working biply. A hooping layer may also be radially on the outside of the working reinforcement, which means to say of any working layer, or radially interposed between two consecutive working layers. A hoop reinforcement as previously described guarantees high circumferential rigidity in the equatorial portion of the tire and, therefore, good control over the radial deformations of the tire caused by centrifuging.

The tire usually comprises a protective reinforcement comprising at least one protective layer radially on the outside of the working reinforcement and the purpose of which is to protect the working reinforcement against mechanical attack of the tread.

At least one protective layer preferably comprises metal reinforcers coated in an elastomeric material. The benefit of having metal reinforcers rather than textile reinforcers as in the working layers is that of guaranteeing effective protection of the working reinforcement against FOD (Foreign Object Damage). These reinforcers are generally wavy in a circumferential direction.

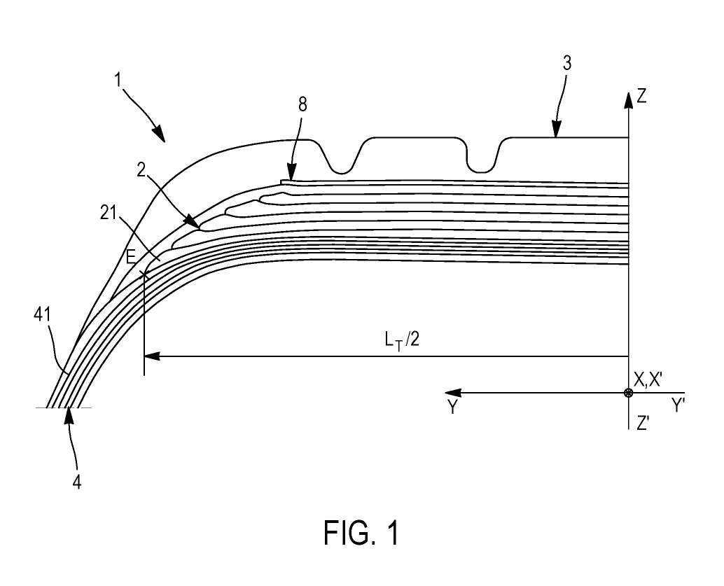

The features and other advantages of the invention will be better understood with the aid of the following FIGS. 1 to 5 which are not drawn to scale:

FIG. 1: A half-view in cross section of the crown of an aeroplane tire of the prior art, the section being in a radial plane (YZ) passing through the axis of rotation (YY′) of the tire.

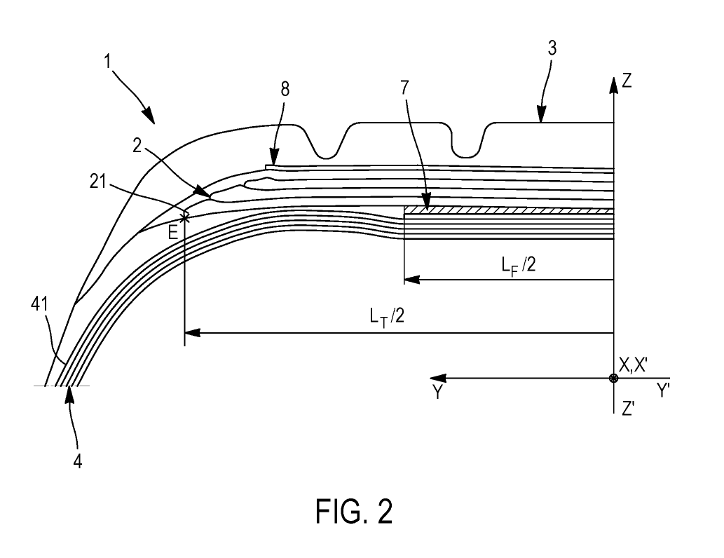

FIG. 2: A half-view in cross section of the crown of an aeroplane tire according to the invention, the section being in a radial plane (YZ) passing through the axis of rotation (YY′) of the tire.

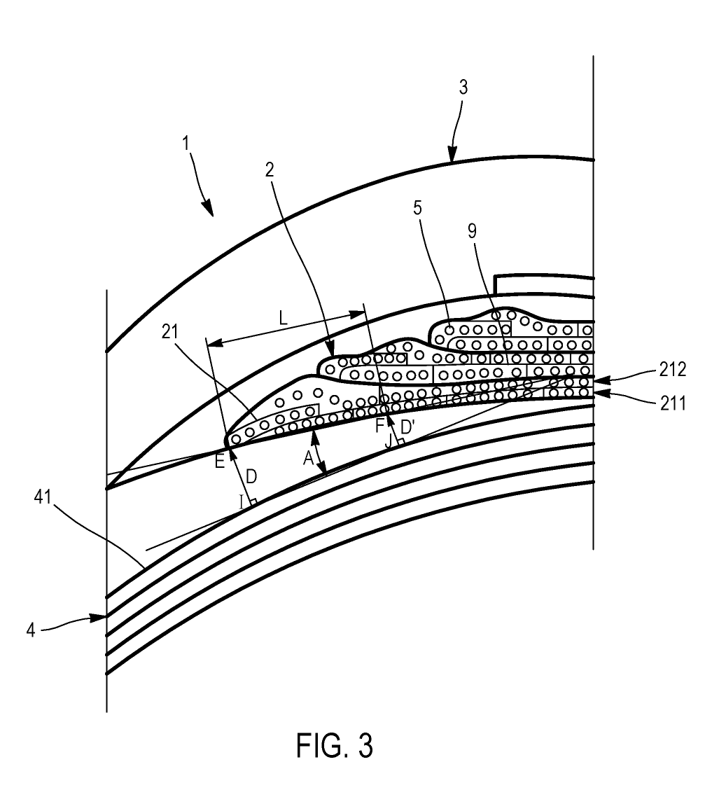

FIG. 3: A detailed view in cross section of the axial end of the working reinforcement of an aeroplane tire according to the invention, the section being in a radial plane (YZ) passing through the axis of rotation (YY′) of the tire.

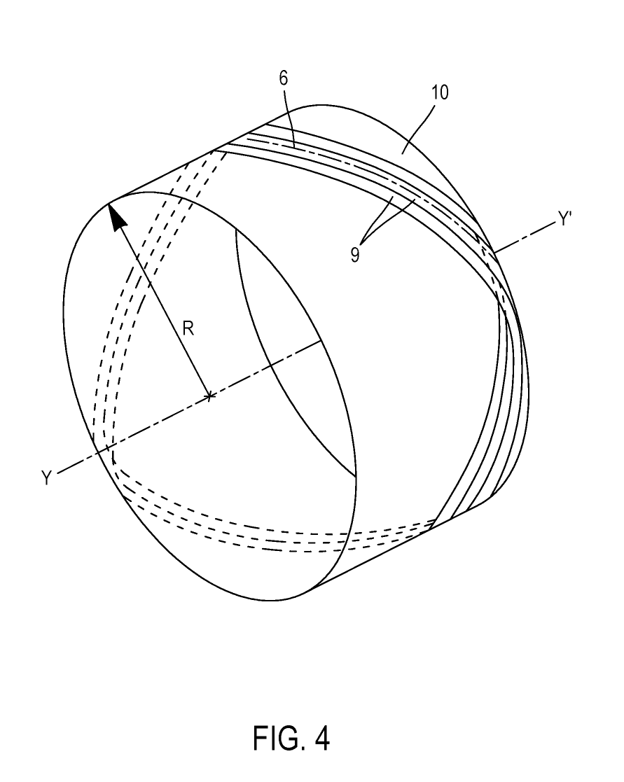

FIG. 4: A perspective view of a strip, that makes up a working biply of an aeroplane tire, circumferentially wound in a zigzag along a periodic curve on a cylindrical laying surface.

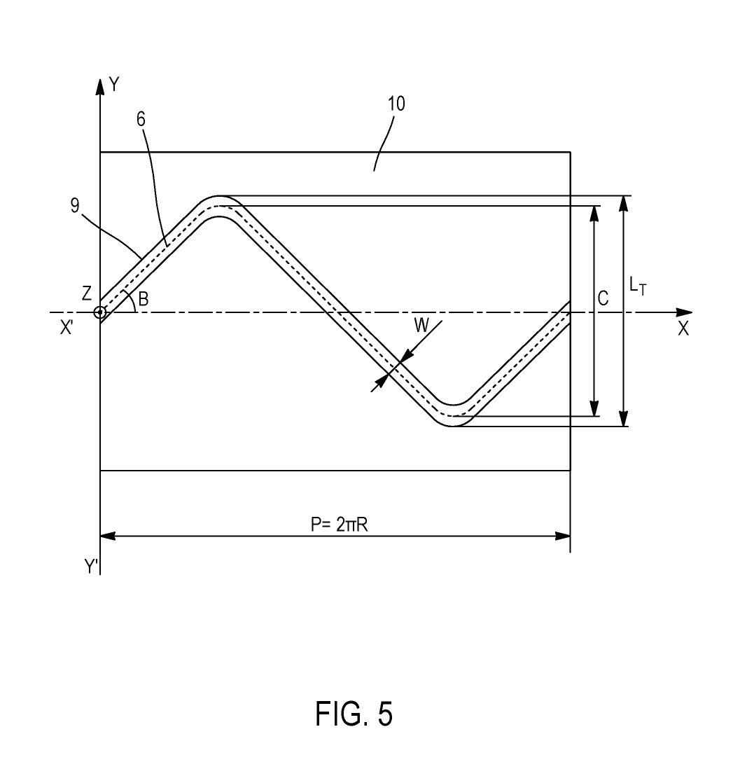

FIG. 5: A developed view of a strip that makes up a working biply of an aeroplane tire, wound circumferentially in a zigzag along a periodic curve after one period has been laid.

FIG. 1 depicts, in a radial plane YZ passing through the axis of rotation YY′ of the tire, a half-view in cross section of the crown of an aeroplane tire 1 according to the prior art, comprising a working reinforcement 2 radially on the inside of a tread 3 and radially on the outside of a carcass reinforcement 4. In the example given, the working reinforcement 2 comprises five working biplies 21, the radially innermost working biply having the greatest axial width L_{T}, measured between its two axial ends. FIG. 1 shows only a half-width L_{T}/2 between an axial end E of the radially innermost working biply 21 and the equatorial plane XZ. Each working biply 21 is made up at least in part of two radially superposed working layers (211, 212) (see FIG. 3). Each working layer (211, 212) comprises textile reinforcers of the aliphatic polyamide type, coated in an elastomeric material. The carcass reinforcement 4 comprises a superposition of carcass layers 41. Each carcass layer 41 comprises textile reinforcers of the aliphatic polyamide type, coated in an elastomeric material and forming, with the circumferential direction XX′ of the tire, an angle at least equal to 80° and at most equal to 100°. Furthermore, radially on the inside of the tread 3, the tire 1 comprises a protective reinforcement 8 made up of a protective layer.

FIG. 2 shows, in a radial plane YZ passing through the axis of rotation YY′ of the tire, a half-view in cross section of the crown of an aeroplane tire 1 according to the invention, comprising a working reinforcement 2 radially on the inside of a tread 3 and radially on the outside of a carcass reinforcement 4. In the example given, the working reinforcement 2 comprises three working biplies 21, the radially innermost working biply having the greatest axial width L_{T}, measured between its two axial ends E. FIG. 2 depicts only a half-width L_{T}/2, between an axial end E of the radially innermost working biply 21 and the equatorial plane XZ. Each working biply 21 is made up at least in part of two radially superposed working layers (211, 212) (see FIG. 3). Each working layer (211, 212) comprises hybrid reinforcers made up of a combination of an aliphatic polyamide and of an aromatic polyamide. The carcass reinforcement 4 comprises a radial superposition of carcass layers 41. Each carcass layer 41 comprises hybrid reinforcers made up of a combination of an aliphatic polyamide and of an aromatic polyamide and forming, with the circumferential direction XX′ of the tire, an angle at least equal to 80° and at most equal to 100°. Furthermore, the tire 1 comprises a hoop reinforcement 7 comprising a hooping layer comprising reinforcers coated in an elastomeric material forming, with the circumferential direction (XX′) of the tire, an angle at most equal to 5°. The hooping layer is radially on the inside of the radially innermost working biply 21 and has an axial width L_{F} at most equal to 0.8 times the axial width L_{T} of the radially innermost working biply 21. FIG. 2 depicts only an axial half-width L_{F}/2 of the hooping layer. According to the invention, the geometric profile of the radially innermost working biply 21, at its axial end E, is not pressed as firmly against the carcass reinforcement as is the case in the tire of the prior art depicted in FIG. 1. Finally, radially on the inside of the tread 3, the tire 1 comprises a protective reinforcement 8 made up of a protective layer.

FIG. 3 is a detailed view in cross section of the axial end of the working reinforcement 2 of an aeroplane tire 1 according to the invention, in a radial plane YZ passing through the axis of rotation YY′ of the tire. In the example given, the working reinforcement 2 comprises three working biplies 21, the respective axial ends of which have overthicknesses. Each working biply 21 is made up of two radially superposed working layers (211, 212) in the main section and of three working layers in the axial end zone. Each working layer (211, 212) is made up of the axial juxtaposition of strips 9, each strip itself being an axial juxtaposition of textile reinforcers 5 coated in an elastomeric compound. In this instance, the textile reinforcers 5 are hybrid reinforcers made up of a combination of an aliphatic polyamide and of an aromatic polyamide. The carcass reinforcement 4 comprises a radial superposition of carcass layers 41, each carcass layer 41 comprising hybrid reinforcers made up of a combination of an aliphatic polyamide and of an aromatic polyamide and forming, with the circumferential direction XX′ of the tire, an angle at least equal to 80° and at most equal to 100°. According to the invention, the distance D between an axial end E of the radially innermost working biply 21 and its orthogonal projection I onto the radially outermost carcass layer 41 is at least equal to 8 mm and the distance D′ between the point F of the radially innermost working biply 21, axially on the inside of the axial end E at a distance L equal to 25 mm, and its orthogonal projection J onto the radial outermost carcass layer 41 is at most equal to the distance D and is such that the angle A equal to atan[(D−D′)/L] is at least equal to 12°. The angle A is the angle formed by the straight line passing through the axial end E of the radially innermost working biply 21 and through the point F of said biply, positioned 25 mm axially on the inside, and the straight line passing through their respective orthogonal projections I and J onto the radially outermost carcass layer 41.

FIG. 4 is a perspective view of a strip 9 that makes up a working biply of an aeroplane tire, circumferentially wound in a zigzag, along a periodic curve 6, onto a cylindrical laying surface 10 exhibiting symmetry of revolution about the axis of rotation (YY′) of the tire, having a radius R.

FIG. 5 is a developed view of a strip 9 that makes up a working biply of a tire according to the invention, circumferentially wound in a zigzag, along a periodic curve 6, after one period has been laid. The strip 9 is laid on a cylindrical surface 10 of circumference 2ΠR, depicted in developed form. The midline of the strip 9 follows a periodic curve 6, forming an angle B with the circumferential direction XX′. The periodic curve 6 has a period P equal to 2ΠR and an amplitude C which, increased by the width W of the strip 9, defines the width L_{T}=C+W of the working biply.

The inventors carried out the invention for an aeroplane tire of size 46X17 R 20 the working reinforcement of which comprises 3 radially superposed working biplies. They compared a reference tire and a tire according to the invention, both having a working reinforcement comprising 3 radially superposed working biplies the reinforcers of which are hybrid reinforcers. The two tires, respectively the reference tire and the tire according to the invention, differ in terms of the geometric profile of the radially innermost working biply at its axial end, said profile being said to be pronounced in the case of the tire according to the invention.

The geometric characteristics of the tires under investigation are given in Table 1 below:

TABLE 1

| | Reference | Invention | Difference |
|---|---|---|---|
| Distance D (mm) | 5 mm | 9 mm | 4 mm |
| Distance D′ (mm) | 2 mm | 2.5 mm | 0.5 mm |
| Distance L (mm) | 25 mm | 25 mm | |
| A = atan[(D-D′)/L] (°) | 6.8° | 12.4° | 5.6° |

The distances D, D and L are measured on a radial cross section of the tire.

The distance D is measured, at right angles to the radially outermost carcass layer, between the radially innermost point of the penultimate reinforcer of the radially innermost working biply and the radially outermost point of the first reinforcer encountered in the radially outermost carcass layer.

The distance D is measured, perpendicular to the radially outermost carcass layer, between the radially innermost point of the reinforcer of the radially innermost working biply, axially on the inside of the axially outermost reinforcer of the radially innermost working biply at a distance of 25 mm, and the radially outermost point of the first reinforcer encountered in the radially outermost carcass layer.

The distance L is measured as being the radius equal to 25 mm of the circle centred on the axially outermost reinforcer of the radially innermost working biply.

The respective performance of the tires of the prior art, considered by way of reference, and according to the invention, were measured against three criteria: the temperature in the vicinity of the axial end of the radially innermost working biply, the maximal tensile load in the reinforcers at the axial end of the radially innermost working biply over one revolution of the wheel, and the maximum number of cycles achieved without damage during a TSO test. The first two criteria came from a finite element numerical simulation on the assumption of steady-state running of the tire at a speed of 10 km/h. The number of cycles without damage were determined by TSO tests.

The performance criteria for the tires studied are given in Table 2 below:

TABLE 2

| | Reference | Invention | Difference |
|---|---|---|---|
| Temperature at the axial end | 93° C. | 88° C. | 5° C. |
| under steady-state running at | | | |
| 10 km/h (° C.) | | | |
| Maximum tensile load at the axial | 20 daN | 18 daN | 2 daN |
| end, over one revolution of the | | | |
| wheel, in steady-state running at | | | |
| 10 km/h (daN) | | | |
| Number of cycles in TSO test | base 100 | 103 | 3 |

This invention is applicable not only to an aeroplane tire but also to any tire comprising a crown reinforcement with at least one biply obtained by a zigzag winding of a strip such as, for example and nonexhaustively, a pneumatic tire for a metro train.

1. An airplane tire comprising:
a working reinforcement radially on the inside of a tread and radially on the outside of a carcass reinforcement;
the working reinforcement comprising at least one working biply having two radially superposed working layers;
each of said working layers comprising reinforcers coated in an elastomeric material, positioned circumferentially along a periodic curve and forming, with the circumferential direction of the tire and in the equatorial plane of the tire, an angle at least equal to 8° and at most equal to 30%;
the radially innermost working biply having the greatest axial width (L_{T}) and comprising two axial ends (E) each one corresponding to the axially outermost and radially innermost point of the working biply;
the carcass reinforcement comprising at least one carcass layer comprising reinforcers which are coated in an elastomeric material, forming, with the circumferential direction of the tire, an angle at least equal to 80° and at most equal to 100°;
wherein the distance (D) between an axial end (E) of the radially innermost working biply and its orthogonal projection onto the radially outermost carcass layer is at least equal to 8 mm and wherein the distance (D′) between the point (F) on the radially innermost working biply, axially on the inside of the axial end (E) at a distance (L) equal to 25 mm, and its orthogonal projection onto the radially outermost carcass layer is at most equal to the distance (D) between an axial end (E) of the radially innermost working biply and its orthogonal projection onto the radially outermost carcass layer and is such that an angle (A) equal to atan[(D−D′)/L] is at least equal to 12°.

2. The airplane tire according to claim 1, wherein the distance (D) between the axial end (E) of the radially innermost working biply and its orthogonal projection onto the radially outermost carcass layer is at most equal to 16 mm.

3. The airplane tire according to claim 1, wherein the distance (D′) between the point (F) on the radially innermost working biply, axially on the inside of the axial end (E) at a distance (L) equal to 25 mm, and its orthogonal projection onto the radially outermost carcass layer is such that the angle (A) equal to atan[(D−D′)/L] is at least equal to 15°.

4. The airplane tire according to claim 1, wherein the distance (D′) between the point (F) on the radially innermost working biply, axially on the inside of the axial end (E) at a distance (L) equal to 25 mm, and its orthogonal projection onto the radially outermost carcass layer is such that the angle (A) equal to atan[(D−D′)/L] is at most equal to 30°.

5. The airplane tire according to claim 1, wherein the reinforcers of the working layers of any working biply are made of a textile material.

6. The airplane tire according to claim 1, wherein the reinforcers of the working layers of at least the radially innermost working biply are hybrid reinforcers made up of a combination of an aliphatic polyamide and an aromatic polyamide.

7. The airplane tire according to claim 1, wherein the tire comprises a hoop reinforcement comprising at least one hooping layer comprising reinforcers which are coated in an elastomeric material, forming, with the circumferential direction of the tire, an angle at most equal to 5°, at least one hooping layer being radially on the inside of the radially innermost working biply and having an axial width (L_{F}) at most equal to 0.8 times the axial width (L_{T}) of the radially innermost working biply.

8. The airplane tire according to claim 1, wherein the tire comprises a protective reinforcement comprising at least one protective layer.

9. The airplane tire according to claim 8, wherein at least one protective layer comprises metal reinforcers coated in an elastomeric material.
